(19) United States
(12) Patent Application Publication
(10) Pub. No.: US 2007/0025337 A1
(43) Pub. Date: Feb. 1, 2007

(54) Technique for providing ancillary information to an entity in a communications network

(75) Inventor: James M. Polk, Colleyville, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Cisco Technology, Inc., San Jose, CA (US)

(21) Appl. No.: 11/263,750

(22) Filed: Nov. 1, 2005

Related U.S. Application Data
(60) Provisional application No. 60/704,072, filed on Jul. 29, 2005.

(51) Int. Cl. H04L 12/66

(52) U.S. Cl. 370/352

(57) ABSTRACT

A technique for providing ancillary information relative to an entity's location to the entity using a host configuration protocol. An entity generates a request containing an option that specifies the ancillary information relative to the entity's location that is sought. The request is forwarded to a server in accordance with the host configuration protocol. The server processes the request including identifying the requested information, generates a response and places the identified information in the response. The server then forwards the response to the entity in accordance with the host configuration protocol. The entity receives the response and processes it, accordingly.

### RELATED APPLICATION

This application claims the benefit of U.S. Provisional Application No. 60/704,072, entitled “Technique For Downloading Ancillary Information To An Entity In A Communications Network,” by James M. Polk, filed on Jul. 29, 2005, the entire teachings of which are incorporated herein by reference.

### FIELD OF THE INVENTION

This invention relates to communication networks and in particular to providing ancillary information to an entity in a communications network relative to the entity's location.

### BACKGROUND OF THE INVENTION

A communication network is a geographically distributed collection of nodes interconnected by communication links and segments for transporting communications (e.g., data) between communication units (end nodes), such as personal computers, certain telephones, personal digital assistants (PDAs), video units and the like. Many types of communication networks are available, with the types ranging from local area networks (LANs) to wide area networks (WANs). LANs typically connect nodes over dedicated private communications links located in the same general physical location, such as a building or campus. WANs, on the other hand, typically connect large numbers of geographically dispersed nodes over long-distance communications links, such as common carrier telephone lines. The Internet is an example of a WAN that connects various networks throughout the world, providing global communication between nodes on the various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

A communication network may comprise a series of intermediate nodes (e.g., routers) that are configured to carry communications through the network to the end nodes. Routers are often configured to “route” data, such as packets, between various nodes in the network. Routing is typically performed at layer-3 (L3), which is the network layer of the Open Systems Interconnection Reference Model (OSI-RM). Routers often maintain forwarding databases (FDBs) which are typically configured to hold routing information (e.g., L3 addresses) and interface information that the router uses to determine where data are to be forwarded in order to reach their destination. For example, a router may have a routing database containing one or more entries wherein each entry contains a L3 destination address of a destination node and interface information about an interface on the router through which the destination node may be reached. Data (e.g., a data packet) containing a destination address that matches a destination address of an entry in the routing table is forwarded by the router to the interface specified by the matching entry for transfer to the destination node.

A router may execute one or more routing protocols that enable the router to route packets and exchange routing information with other routers in the network. The routers often use the exchanged routing information to configure (e.g., compute) their FDBs. The routing protocols may include distance-vector protocols, such as the Routing Information Protocol (RIP), or link-state protocols, such as the Intermediate-System-to-Intermediate-System (IS-IS) protocol and the Open Shortest Path First (OSPF) protocol.

Routing information is typically exchanged between the routers in the form of advertisement messages. For example, nodes executing the IS-IS protocol exchange routing information using an advertisement message called a Link State Packet (LSP). Likewise, nodes executing the OSPF protocol exchange routing information using an advertisement message called a Link State Advertisement (LSA). An intermediate node that acquires an advertisement message may use information contained therein to update its FDB.

Communication networks are increasingly being used to transport many forms of information including, e.g., voice and video information. Information may be carried on a communication network using various technologies, such as Voice over IP (VoIP). VoIP refers to a group of technologies that may be used to transmit e.g., voice information over communication networks from a source (calling party) to a destination (called party). Such networks may include a plurality of agents that convert e.g., voice and/or video information from its traditional form to a form that is suitable for packet transmission. In other words, the agent encodes, compresses and encapsulates the information into a plurality of data packets that are suitable for being carried by the communication network. Examples of agents include IP telephones, VoIP network interfaces, certain private branch exchanges (PBXs), personal computers (PCs) running communication applications, certain personal digital assistants (PDAs), network devices providing voice gateway services and so on.

In certain communication networks, such as VoIP networks and IP networks, a session protocol may be employed to establish a VoIP session (connection) that supports a call between a calling party and a called party. An example of a session protocol that is commonly used is the well-known Session Initiation Protocol (SIP) which is described in J. Rosenberg et al., “SIP: Session Initiation Protocol,” Internet Engineering Task Force (IETF) Request For Comments (RFC) 3261. SIP operates at the application layer of the OSI-RM and is defined to establish and maintain sessions between endpoints (e.g., SIP-based telephones) in a communication network.

In accordance with SIP, endpoints are referred to as User Agents (UAs). When a UA comes on-line, it typically registers with a registration service, called a policy data point (PDP), using a SIP “register” (REGISTER) command. The PDP maintains information about the UA which may include its location, how to reach it and authentication information associated with the UA that may be used to authenticate the UA. Typically, after a UA is registered, the UA is available to receive as well as initiate calls.

When a call is initiated by a calling party to a called party, a session is typically established between the calling and called parties' UAs to support the call. Establishing. a session between the parties often involves (a) authenticating both parties and (b) successfully exchanging a sequence of messages between the parties in a predetermined manner. Authentication often involves ensuring the parties have permission to establish a call in the network. The sequence of messages may include (a) an “invite” (INVITE) message issued by the calling party to the called party to initiate the session between the calling and called parties, (b) an “OK” (200 OK) message issued by the called party to the calling party to acknowledge the INVITE message and indicate the called party accepts participation in the session followed by (c) an “acknowledgement message” (ACK) issued by the calling party to the called party to acknowledge the called party's acceptance. After the session is established, a channel may then be established, e.g., in accordance with the Real-time Transport Protocol (RTP) described in H. Schulzrinne et al., “RTP: A Transport Protocol for Real-Time Applications,” IETF RFC 3550, to carry traffic (e.g., voice information) between the parties.

Some communication networks, such as IP-based communication networks, enable an entity to acquire information, such as an address that the entity uses to communication with other entities in the network and a geographical location associated with the entity. Here, the entity may employ a query/response protocol, such as the well-known Dynamic Host Configuration Protocol (DHCP), to acquire this address and geographical location information. In a typical arrangement, the entity broadcasts a DHCP request to a DHCP server in the network to acquire the address and/or geographical location information from the DHCP server. The DHCP server receives the request and processes it including locating the requested information and placing it in a response. The DHCP server then forwards the response to the entity. The entity receives the response and processes it accordingly.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of an exemplary communication network that may implement the present invention.

FIG. 2 is a block diagram of a communication unit that may be used with the present invention.

FIG. 3 is a block diagram of an entity server that may be used with the present invention.

FIG. 4 illustrates a Dynamic Host Configuration Protocol (DHCP) database that may be used with the present invention.

FIG. 5 illustrates a DHCP message that may be used with the present invention.

FIG. 6 illustrates a dialog between a communication unit and a server for requesting ancillary information relative to the communication unit's location in accordance with an aspect of the present invention.

FIG. 7 is a flow chart of a sequence of steps that may be used to request ancillary information relative to an entity's location from a server in accordance with an aspect of the present invention.

### DETAILED DESCRIPTION OF THE INVENTION

A description of preferred embodiments of the invention follows.

One problem with existing techniques is that while it may be possible for an entity to acquire configuration and geographic location information from a server using a host configuration protocol, such as the Dynamic Host Configuration Protocol (DHCP), it may not be possible to acquire certain ancillary information relative to the entity's location using such protocols. This ancillary information may include, e.g., a Uniform Resource Identifier (URI), Uniform Resource Locator (URL) or Uniform Resource Name (URN) associated with a Public Safety Access Point (PSAP) that services the entity's geographic location or URIs, URLs, URNs associated with restaurants, stores, and other places of interest that are within a certain proximity of the entity's geographic location.

The present invention overcomes shortcomings associated with the prior art by incorporating a technique for providing ancillary information to an entity in a communication network relative to the entity's location (e.g., geographic location) using a host configuration protocol. According to an aspect of the present invention, an entity generates a request containing. Optionally, the request may contain an option that specifies what ancillary information is sought by the entity. The request is forwarded to a server via a host configuration protocol, such as DHCP. The server processes the request including locating the ancillary information, generates a response and places the located ancillary information in the response. The server then forwards the response to the entity via the host configuration protocol. The entity receives the response containing the ancillary information and processes it, accordingly.

Illustrative embodiments of the invention are described below as using the DHCP protocol and the Session Initiation Protocol (SIP). It should be noted, however, that host configuration protocols other than DHCP and session management protocols other than SIP may be adapted to take advantage of the present invention.

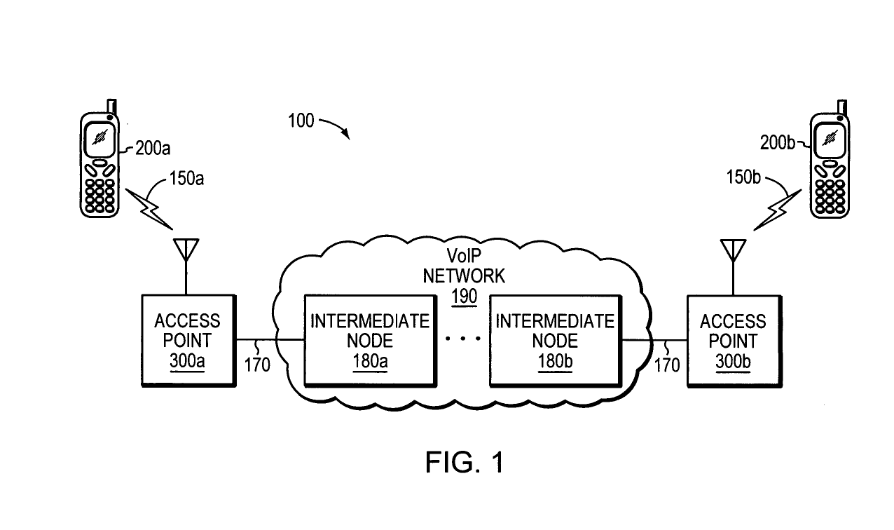

FIG. 1 is a high-level block diagram of an exemplary communication network 100 that may implement the present invention. Communication network 100 comprises a collection of communication links 170 interconnecting a plurality of nodes such as communication units 200, access points 300 and intermediate nodes 180 to form an internetwork of nodes. These internetworked nodes communicate by exchanging data packets according to a pre-defined set of network protocols, such as the Transmission Control Protocol/Internet Protocol (TCP/IP), the Voice over IP (VoIP) protocol and DHCP. A network protocol as used herein is a formal set of rules that define how data is exchanged between nodes in a communication network.

The intermediate nodes 180 are conventional intermediate nodes, such as routers, that are configured to implement a VoIP network 190. The access points 300 are configured to enable the communication units 200 to transfer information (e.g., data) between the VoIP network 190 and communication units 200. To that end, the access points 300 comprise circuitry which is configured to transmit and receive signals (e.g., radio frequency (RF) signals) that carry the information between the access points 300 and the communication units 200 via wireless links 150. Examples of access points that may be used with the present invention include certain Institute of Electrical and Electronic Engineers (IEEE) 802.11 compliant access points as well as certain cellular telephone wireless systems that support the transfer of data traffic by wireless means.

Communication units 200 are conventional communication units, such as wireless telephones, personal digital assistants (PDAs), IP telephones and the like, that enable, e.g., audible and/or visual communications to be converted into signals that are transferred to the access points 300 via wireless links 150. Information (e.g., voice, video) is typically conveyed between the communication units 200 using calls which are established in network 100 between the communication units 200. It should be noted that the present invention may be adapted to work with fixed as well as mobile devices that are able to communicate via a communication network. These fixed devices may include telephone units, personal computers and the like that are wired to a network, such as an Ethernet network.

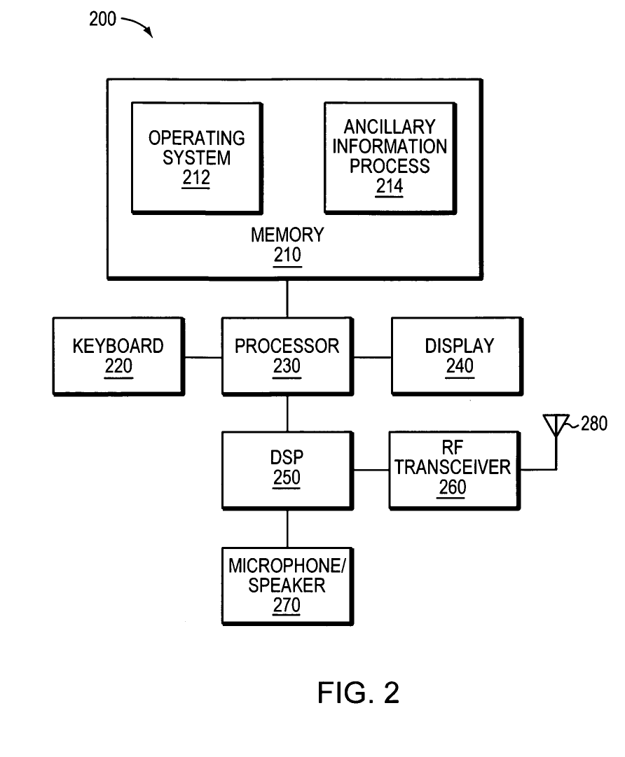

FIG. 2 is a high-level block diagram of an exemplary communication unit 200 that may be used with the present invention. Communication unit 200 comprises a memory 210, a keyboard 220, a CPU 230, a display unit 240, a digital signal processor (DSP) 250, an RF transceiver 260, a microphone/speaker 270 and an antenna 280. The keyboard 220 is a conventional keyboard device that enables information to be input into the communication unit, e.g., by a user. The processor 230 is a conventional central processing unit (CPU) configured to execute computer-executable instructions contained in memory 210 including instructions that implement aspects of the present invention.

The display unit 240 is a conventional display unit that enables images (e.g, text, icons, pictures) to be displayed on the communication unit 200. The DSP 250 is a conventional digital signal processor that is capable of processing various analog and/or digital signals generated by e.g., the RF transceiver 260 and microphone/speaker 270 as well as providing various digital and/or analog signals to the microphone/speaker 270 and the RF transceiver 260. The microphone/speaker 270 enables audio to be input into the communication unit 200 as well as output from the communication unit 200.

The RF transceiver 260 is a conventional RF transceiver that enables signals to be transferred between the network 100 and the communication unit 200 via an antenna 280. It should be noted that transceiver 260 may be capable of transferring information between the communication unit 200 and the access point 300 using means other than RF. For example, the transceiver 260 may be configured to transmit and receive information using infrared frequencies, light, wired means, sub-RF frequencies and the like.

The memory 210 is a computer-readable medium implemented as a random access memory (RAM) comprising RAM devices, such as dynamic RAM (DRAM) devices and/or flash memory devices. Memory 210 contains various software and data structures used by the processor 230 including software and data structures that implement aspects of the present invention. Specifically, memory 210 includes an operating system 212 and an ancillary information process 214. The operating system 212 functionally organizes the communication unit 200 by invoking operations in support of software processes and services executing on the communication unit 200, such as ancillary information process 214. Process 214 comprises computer-executable instructions to (a) generate requests for ancillary information associated with the communication units, (b) forward the requests to the access points 300 and (c) process responses to the requests received from the access points 300.

Access points 300 are conventional access points that implement a host configuration protocol, such as DHCP. A host configuration protocol, as used herein, refers to a protocol that provides, inter alia, configuration information to a client (e.g., communication unit 200) that request the information as well information relative to a client's location, such as a URI of a PSAP, in accordance with an aspect of the present invention. Access points 300 are configured to (a) process a request from an entity for ancillary information relative to the entity's location, (b) generate a response to the request wherein the response contains the requested ancillary information and (c) forward the response to the entity. Access point 300 may be a “trusted source” meaning that entities (nodes) in the network 100 consider the access point 300 a reliable (trustworthy) source of information.

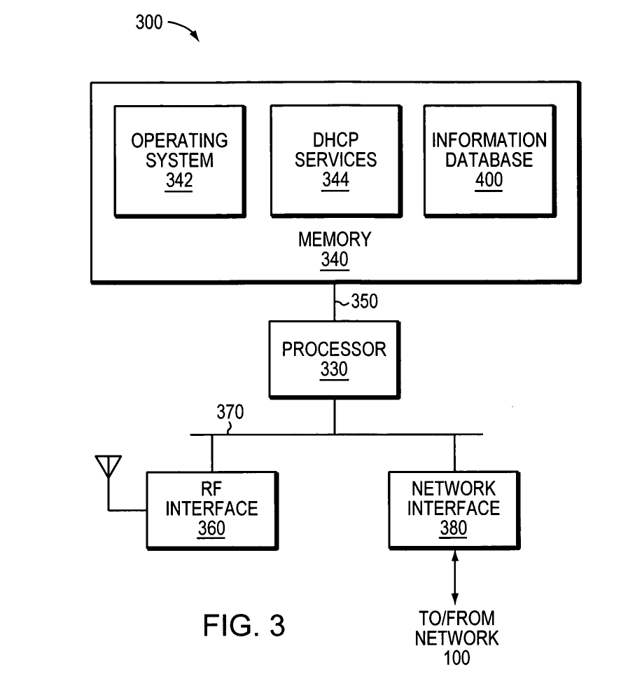

FIG. 3 is a high-level block diagram of an exemplary access point 300 that may be used with the present invention. Access point 300 comprises a memory 340 coupled to a processor 330 via a memory bus 350 and, an radio frequency (RF) interface 360 and a network interface 380 coupled to the processor 330 via an input/output (I/O) bus 370. It should be noted that access point 300 may include other devices, such as a keypad, display units and the like. The network interface 380 interfaces the server 300 with the network 100 and enables data (e.g., packets) to be transferred between the server 300 and other nodes in the network 100. To that end, network interface 380 comprises conventional interface circuitry that incorporates signal, electrical and mechanical characteristics, and interchange circuits, needed to interface with the physical media of the network 100 and protocols running over that media.

The RF interface 360 enables data to be transferred between the access point 300 and the communication units 200 via wireless links 150. To that end, RF interface 360 comprises conventional interface circuitry that incorporates signal, electrical and mechanical characteristics, and interchange circuits, to accommodate transferring data between the communication units 200 and the access point 300 via wireless links 150 using various wireless protocols, such as the protocols described in the Institute of Electrical and Electronic Engineers (IEEE) 802.11 standard. It should be noted that systems that employ other wireless protocols, such as protocols associated with the well-known Global System for Communication (GSM) standard, may take advantage of the present invention.

The memory 340 is a computer-readable medium implemented as a RAM comprising RAM devices, such as DRAM devices and/or flash memory devices. Memory 340 contains various software and data structures used by the processor 330 including software and data structures that implement aspects of the present invention. Specifically, memory 340 includes an operating system 343, DHCP services 344 and information database 400. The operating system 343 functionally organizes the access point 300 by invoking operations in support of software processes and services executing on the access point 300, such as DHCP services 344. The DHCP services 344 comprise computer-executable instructions to implement a DHCP protocol server as well process requests for ancillary information in accordance with an aspect of the present invention.

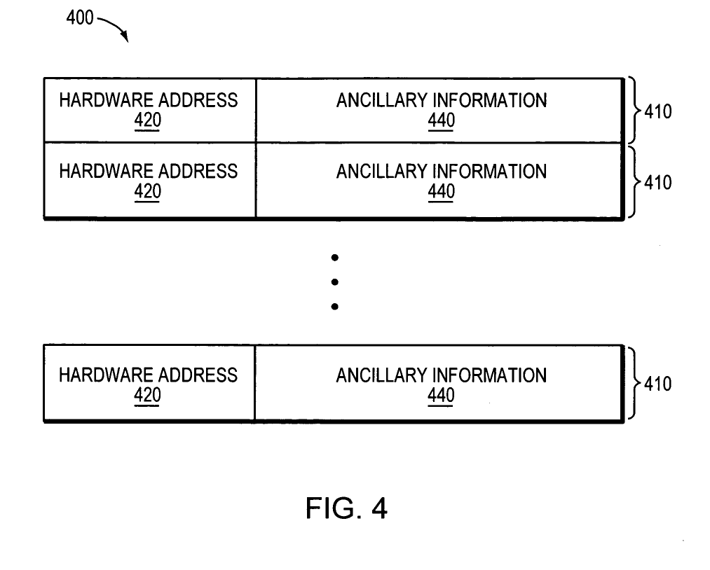

Information database (DB) 400 is configured to hold various information requested by the communication units 200 including ancillary information relative to a communication unit's location. FIG. 4 illustrates an information DB 400 that may be used with the present invention. Information DB 400 is illustratively a preconfigured table comprising one or more entries 410 wherein each entry contains an address field 420 and an ancillary information field 440. The address field 420 holds information that represents an address (e.g., a hardware address) associated with an entity serviced by the access point (e.g., a communication unit 200) and the location ancillary information field 440 holds ancillary information that is associated with a location 420, such as a URI associated with a PSAP. It should be noted that the information field may be used to hold other ancillary information about a location, such as a list of stores, restaurants, other places of interest and so on associated with a location. It should be further noted that database 400 may be preconfigured from information supplied by e.g., node in the network 100 or by a user.

Functions performed by communication units 200 and the access points 300, including functions that implement aspects of the present invention, may be implemented in whole or in part using some combination of hardware and/or software. It should be further noted that computer-executable instructions and/or computer data that implement aspects of the present invention may be stored in various computer-readable mediums, such as volatile memories, non-volatile memories, flash memories, removable disks, non-removable disks and so on. In addition, it should be noted that various electromagnetic signals, such as wireless signals, electrical signals carried over a wire, optical signals carried over optical fiber and the like, may be encoded to carry computer-executable instructions and/or computer data that implement aspects of the present invention on e.g., a communication network.

In accordance with an aspect of the present invention, an entity in network 100, such as a communication unit 200, requests information contained in the DHCP database 400 by sending a DHCP request message to an access server 300 that services the entity. The access server 300 processes the request message, generates a DHCP response message and returns the information in an option contained in the response message.

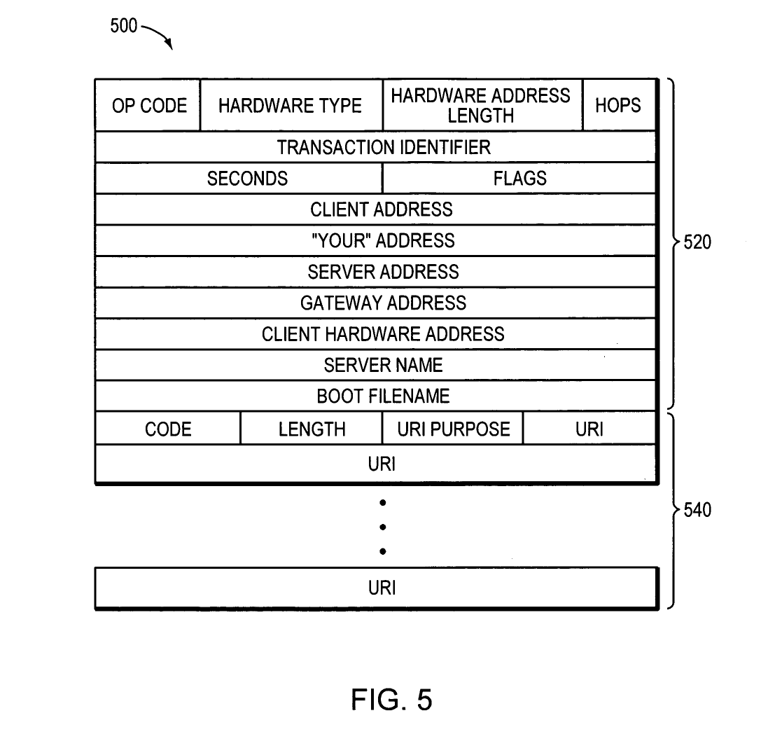

FIG. 5 is a block diagram of a DHCP message 500 that may be used with the present invention. Message 500 may be adapted to be used as a DHCP request message or a DHCP response message. Message 500 includes various DHCP information 520 and a URI option 540. The DHCP information 520 contains conventional DHCP message fields including operation (OP) code, hardware type, hardware address length, hops, transaction identifier, seconds, flags, client address, “your” address, server address, gateway address, client hardware address, server name and boot filename fields.

The OP code field holds a value that indicates whether the message is a DHCP request message or a DHCP response message. The hardware type and hardware address length fields hold values that specify a type of hardware used to by the entity to access the network and a length of the hardware addresses in the message, respectively. The hops field holds a value that specifies hop information that may be used by various nodes to control the forwarding of various messages (e.g., DHCP messages). The transaction identifier field holds a value that may be used to identify a request and match the request to a particular response. The seconds field holds a value that indicates a number of seconds that has elapsed since a client began an attempt to acquire a lease. The flags field holds a value that indicates various flags associated with the request. The client address field holds a value that represents a client address (e.g., an IP address of the client). The “your” address field holds a value that represents an address assigned to the client by the DHCP server. The server address field holds a value that represents an address associated with the DHCP server. The gateway address field holds a value that represents an address associated with a gateway device. The client hardware address field holds a value that represents a value that represents a hardware address of the client. The server name field includes a value of a name associated with the DHCP server and the boot filename field typically holds information regarding a specific boot file requested by a client.

The option 540 contains a code field, a length field, a URI purpose field and a URI. The code field holds a value that identifies the option 540 as a URI option. The length field holds a value that represents a length of the option 540, illustratively in bytes. The URI purpose field contains a value that represents a purpose of the URI in the URI field. Illustratively this field is coded as described in Table 1.

TABLE 1

| Value | Purpose |
|---|---|
| 1 | A URI of a PSAP as determined by an Internet Access Provider (IAP) or |
| | Enterprise network; |
| 2 | A URI or URL of the location of the client ‘by-reference’ as determined by the |
| | IAP or enterprise network; |
| 3 | A URI of Emergency Services Gateway (ESGW) to be used in hybrid |
| | IP/circuit-switched scenarios in which the IP portion knows in order to get |
| | to the PSAP, it must communicate with a specific gateway; |
| 4 | A URI of Emergency Services Routing Proxy, a SIP intermediary Proxy |
| | that is able to perform routing functionality of an INVITE request that |
| | contains a Presence Information Data Format - Location Object (PIDF-LO) |
| | location message body of a client; |
| 5 | A URI or URL of a responsible organization that provided location |
| | information via DHCP (This should be for whoever runs the backend server |
| | that supplies location mapping to the DHCP server that it uses to populate replies |
| | to a request for location information as defined in RFC 3825); |
| 6 | A URI or URL of a server that will provide “location” for the client (it is |
| | expected that this client will use another protocol (e.g., SIP) to fetch this |
| | location information from the server at this returned URI). |

The URI field holds a value that represents a URI associated with the information sought by the entity that is being returned to the entity. Note that, in a DHCP request, the option 540 specifies what information ancillary to an entity's location is sought by the entity and in a DHCP response, the option 540 specifies the ancillary information that is sought by the entity.

It should be noted that in other embodiments of the invention, including the option 540 in the request and/or response is considered optional. Here, for example, a server that receives a request that does not contain an option 540 may (a) automatically assume that certain information ancillary to an entity's location (e.g., a URI associated with a PSAP servicing the entity's location) is being sought and (b) automatically include this information in its response to the entity either in an option 540 or by some other means.

The SIP protocol is described in J. Rosenberg et al., “SEP: Session Initiation Protocol,” RFC 3261, June 2002, available from the Internet Engineering Task Force (IETF) and is incorporated by reference in its entirely as though fully set forth herein. PDIF-LOs are described in J. Peterson, “A Presence-based GEOPRIV Location Object Format,” draft-ietf-geopriv-pidf-lo-03.txt, September 2004, available from the IETF and which is hereby incorporated by reference in its entirety as though fully set forth herein. A version of the DHCP protocol that may be used with the present invention is described in R. Droms, “Dynamic Host Configuration Protocol,” RFC 2131, March 1997, and a DHCP option for coordinate LCI that may be used with the present invention is described in J. Polk et al. “Dynamic Host Configuration Protocol Option for Coordinate Based Location Configuration Information” RFC 3825, July 2004, both of which are available from the IETF and are hereby incorporated by reference in their entirety as though fully set forth herein.

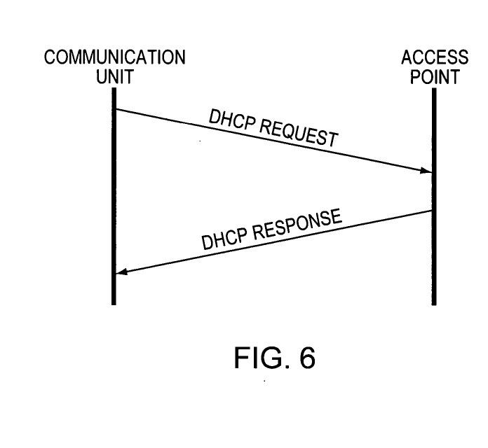

In accordance with an aspect of the present invention, an entity (e.g., communication unit 200) requests (seeks) ancillary information relative to the entity's location (e.g., geographic location) from a host configuration protocol server (e.g., access device 300) by (a) issuing a request that specifies the type of information being sought from the server (e.g., a URI associated with a PSAP) and (b) receiving a response containing the information sought. FIG. 6 illustrates a dialog between a communication unit 200 and an access point 300 configured to be a DHCP server to request and receive ancillary information relative to the communication unit's location from the access point 300 in accordance with an aspect of the present invention.

Referring to FIG. 6, the communication unit 200 generates a DHCP request message containing a URI option 540 to indicate it is seeking information from the access point 300. The access point 300 receives the DHCP request message, locates the requested information and responds to the request with a DHCP response message that contains a URI option configured to hold the requested information.

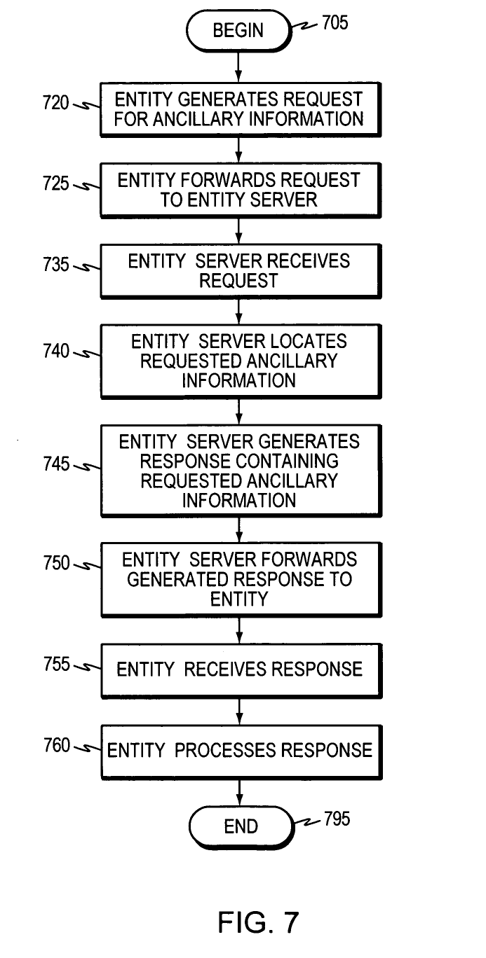

FIG. 7 is a flow chart of a sequence of steps that may be used to request ancillary information associated with an entity's location from a host configuration protocol server in accordance with an aspect of the present invention. The sequence begins at step 705 and proceeds to step 720 where an entity generates a request for the ancillary information. Next, at step 725, the entity forwards the request to the host configuration protocol server. At step 735, the server receives the request and, at step 740, locates the requested ancillary information. At step 745, the server generates a response containing the requested ancillary information and, at step 750, forwards it to the entity. At step 755, the entity receives the response containing the ancillary information and, at step 760, processes it accordingly. This processing may include extracting the requested information and storing it locally on the entity. The sequence ends at step 795.

For example, referring to FIG. 1, assume communication unit 200a wishes to acquire the URI of a PSAP that services the communication unit's location. Further, assume that the access point 300a is a DHCP server configured to process requests for ancillary information from the communication unit 200a and that its DHCP database 400 has been preconfigured with the PSAP URI information sought by communication unit 200a.

The communication unit 200a generates a DHCP request 500 (step 720) and forwards it to the access point 300a (step 725). Illustratively, the communication unit's processor 230 generates a DHCP request 500 containing the hardware address of the communication unit 230 and a URI option 540 that specifies that the URI of a PSAP is being requested. The processor 230 then forwards the request 500 to the access point 300a via the DSP 250 and RF transceiver 260 which transfers the request via antenna 280 onto the wireless link 150a to the access point 300a.

The access point 300a receives the request 500 (step 735) and processes it (step 740). Illustratively, the access point's RF interface 360 receives the request 500 from the wireless link 150a and forwards it to the access point's processor 330 via bus 370. The processor 330 processes the request 500 including using the hardware address therein to locate an entry 410 in the DHCP database 400 whose hardware address 420 matches the hardware address specified in the request 500. Assuming a matching entry 410 is found, the processor 330 examines the URI option 540 in the request to determine the information sought and extracts the requested information from the ancillary information field 440 of the matching entry 410.

The access point 300a then generates a response 500 containing the requested information (step 745) and forwards the response 500 to the communication unit 200a step 750). Illustratively, processor 330 generates a DHCP response message 500 containing a URI option 540 and places the requested information extracted from the ancillary information field 440 in the URI field of the URI option 540. The processor 330 then forwards the generated response 500 via bus 370 to the RF interface 360 which transfers the response 500 onto wireless link 150a to communication unit 200a.

The communication unit 200a receives the response 500 (step 755) and processes it (step 760). Illustratively, the response is received from the wireless link 150a by the communication unit's RF transceiver 260 via antenna 280 and forwarded to the processor 230 via DSP 250. The processor 230 processes the request 500 which may include extracting the requested URI information from the request's URI option 540 and placing the URI information in memory 210.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for providing ancillary information to an entity in a communication network wherein the ancillary information is relative to the entity's location, the method comprising:
generating a request;
forwarding the request to a server using a host configuration protocol; and
receiving a response from the server via the host configuration protocol wherein the response contains the ancillary information relative to the entity's location.

2. A method as defined in claim 1 wherein the response contains an option that specifies the ancillary information.

3. A method as defined in claim 1 wherein the host configuration protocol is the Dynamic Host Configuration Protocol (DHCP).

4. A method as defined in claim 1 wherein the ancillary information is information associated with a Public Safety Access Point (PSAP).

5. A method as defined in claim 4 wherein the ancillary information is a Uniform Resource Identifier (URI) that is associated with the PSAP.

6. A method as defined in claim 1 wherein the entity's location is a geographic location.

7. A method for providing ancillary information to an entity in a communication network wherein the ancillary information is relative to the entity's location, the method comprising:
receiving a request from an entity via a host configuration protocol;
locating ancillary information relative to the entity's location;
generating a response wherein the response has an option containing the ancillary information; and
forwarding the response to the entity using the host configuration protocol.

8. A method as defined in claim 7 wherein the request contains an option that specifies what ancillary information is sought by the entity.

9. A method as defined in claim 10 wherein the host configuration protocol is the Dynamic Host Configuration Protocol (DHCP).

10. A communication unit for acquiring ancillary information relative to an entity's location, the communication unit comprising:
a memory; and
a processor coupled to the memory, the processor configured to:
(a) generate a request,
(b) forward the request to a server using a host configuration protocol, and
(c) receive a response from the server via the host configuration protocol wherein the response contains the ancillary information relative to the entity's location.

11. A communication unit as defined in claim 10 wherein the processor is further configured to store the ancillary information in the memory.

12. A communication unit as defined in claim 10 wherein the response contains an option that specifies the ancillary information.

13. A communication unit as defined in claim 10 wherein the host configuration protocol is the Dynamic Host Configuration Protocol (DHCP).

14. A communication unit as defined in claim 10 wherein the ancillary information is information associated with a Public Safety Access Point (PSAP).

15. A communication unit as defined in claim 14 wherein the ancillary information is a Uniform Resource Identifier (URI) that is associated with the PSAP.

16. A node in a communications network for providing ancillary information relative to an entity's location to the entity, the node comprising:
a network interface configured to receive a request from the entity via a host configuration protocol; and
a processor coupled to the network interface, the processor configured to:
(a) generate a response wherein the response contains the ancillary information, and
(b) forward the response to the entity using the host configuration protocol.

17. A node as defined in claim 16 wherein the response contains an option that specifies the ancillary information.

18. A node as defined in claim 16 wherein the host configuration protocol is the Dynamic Host Configuration Protocol (DHCP).

19. A node as defined in claim 16 wherein the ancillary information is information associated with a Public Safety Access Point (PSAP).

20. A node as defined in claim 19 wherein the ancillary information is a Uniform Resource Identifier (URI) that is associated with the PSAP.

21. In a communication network, an apparatus for providing ancillary information relative to an entity's location to the entity, the apparatus comprising:
means for receiving a request from an entity via a host configuration protocol;
means for generating a response wherein the response has contains the ancillary information; and
means for forwarding the response to the entity using the host configuration protocol.

22. In a communication network, a system for providing ancillary information relative to an entity's location to the entity, the system comprising:
an entity configured to:
(a) generate a request,
(b) forward the request to a server using a host configuration protocol, and
(c) receive a response from the server via the host configuration protocol wherein the response contains the ancillary information relative to the entity's location; and
a node configured to:
(a) receive a request from an entity via a host configuration protocol,
(b) generate a response wherein the response contains the ancillary information, and
(c) forward the response to the entity using the host configuration protocol.
